(19) United States
(12) Patent Application Publication
(10) Pub. No.: US 2009/0290791 A1
(43) Pub. Date: Nov. 26, 2009

(54) AUTOMATIC TRACKING OF PEOPLE AND BODIES IN VIDEO

(76) Inventors: Alex David HOLUB, Sunnyvale, CA (US); Atiq Islam, Santa Clara, CA (US); Andrei Peter Makhanov, Sunnyvale, CA (US); Pierre Moreels, Mountain View, CA (US); Rui Yang, Sunnyvale, CA (US)

Correspondence Address: GLENN PATENT GROUP, 3475 EDISON WAY, SUITE L, MENLO PARK, CA, 94025, US

(21) Appl. No.: 12/468,751

(22) Filed: May 19, 2009

Related U.S. Application Data
(60) Provisional application No. 61/054,804, filed on May 20, 2008.
(60) Provisional application No. 61/102,763, filed on Oct. 3, 2008.

(51) Int. Cl. G06K 9/34

(52) U.S. Cl. 382/164; 382/170

(57) ABSTRACT

A facial detection module detects faces in any frame in a video by applying at least two rectangles between the eyes of a face and other regions and calculating a difference in intensity between those regions. The intensities are used to generate face detections. A tracking module predicts the location of faces in frames across time and compares the predicted location to the face detections. The face detection that is closest to the predicted location is selected, provided that it exceeds a threshold of overlap with the predicted location. A tracking module determines shot boundaries by comparing the similarities between frames. A clustering module groups the face tracks in the shots, as demarcated by the shot boundaries, for individuals within the video. A body detection module attaches a body outline to each of the face tracks to increase the clickable area for the individuals.

### CROSS REFERENCE TO RELATED APPLICATIONS

This patent application claims the benefit of U.S. provisional patent application Ser. No. 61/054,804, System for Tracking Objects, Labeling Objects, and Associating Meta-Data to Web Video, filed May 20, 2008 and U.S. provisional patent application Ser. No. 61/102,763, System for Automatically Tracking Objects within Video, filed Oct. 3, 2008, the entirety of each of which is incorporated herein by this reference thereto.

### BACKGROUND OF THE INVENTION

1. Technical Field

This invention relates generally to the field of tracking objects in videos. More specifically, this invention relates to automatically parsing and extracting meta-information from online videos.

2. Description of the Related Art

Videos are an increasingly popular form of media on the Internet. For example, the news is delivered in video clips on popular websites such as CNN. The website YouTube® is an exceptionally popular website for viewing video clips of people, their pets, and anything else of documentary interest. Television networks, such as NBC, ABC, and Fox have even been licensing their television shows to Hulu to generate increased interest in less popular programs. Much to everyone's surprise, Hulu has becomes a huge success.

Joss Whedon created a video musical for Internet distribution only titled “Dr. Horrible's Sing-Along Blog,” which was released initially on Hulu and later on iTunes®. This video has become so popular, that it may even be made into a movie. This model is very attractive to investors and network producers because the budget for Internet distribution is much lower than television production. “Dr. Horrible,” for example, cost only $200,000.

With the popularity of online videos comes the opportunity to generate advertising revenues. A traditional form of advertising for videos is a pre-roll ad, which is an advertisement that is displayed in advance of the video. Consumers particularly dislike pre-roll ads because they cannot be skipped.

Another form of video advertising involves overlaying ads onto the frames of a video. For example, banner ads are displayed on the top or bottom of the screen. The advertisement typically scrolls across the screen in the same way as a stock ticker, to draw the consumer's attention to the advertisement. Alternatively, a static image of an ad can be overlaid on the screen. Consumers frequently find these overlaid advertisements to be distracting, especially when they are generic ads unrelated to the video content.

In commonly assigned Application Publication Number 2009/0006937, Applicants disclose a method for monetizing videos by breaking up objects within the video and associating the objects with metadata such as links to websites for purchasing the objects, a link to an actor's blog, a website for discussing a particular product or actor, etc.

Identifying people in videos and tracking their movements throughout the video can be quite complicated, especially when the video is shot using multiple cameras and the video toggles between the resulting viewpoints. Viola and Jones disclose an algorithm for identifying faces in an electronic image based on the disparity in shading between the eyes and surrounding features. Milborrow and Nicolls disclose an extended active shape model for identifying facial features in an electronic image based on the comparison of distinguishable points in the face to a template. Neither of the references disclose, however, tracking the identity of the face in a series of electronic images.

### SUMMARY OF THE INVENTION

In one embodiment, methods and systems track people in online videos. A facial detection module identifies the different faces of people in frames of a video. Not only are people detected, but steps are also taken towards recognizing their identity within video content by automatically grouping together frames containing images of the same person. Faces are tracked between frames using facial outlines. A series of frames with the identified faces are grouped as shots. The face tracks of different shots for each person are clustered together. The entire video becomes categorized as homogenous clusters of facial tracks. As a result, a person need only be tagged in the video once to generate an identity for the person throughout the video. In one embodiment, a body detection module associates the face tracks with bodies to increase the clickable areas of the video for additional monetization.

### BRIEF DESCRIPTION OF THE DRAWINGS

FIG. 1 is a block diagram that illustrates a network environment of a system for tracking people in videos according to one embodiment of the invention;

FIG. 2 is a block diagram that illustrates a system for tracking people in videos according to one embodiment of the invention;

FIG. 3A illustrates rectangles that are used in facial detection according to one embodiment of the invention;

FIG. 3B illustrates an integral image at x, y according to one embodiment of the invention;

FIG. 4 illustrates the application of rectangles to an image of a face during the facial recognition process according to one embodiment of the invention;

FIG. 5 illustrates a video sequence that is divided into shots according to one embodiment of the invention;

FIG. 6 illustrates an outline at time t and candidate outlines at time t+1 according to one embodiment of the invention;

FIG. 7 illustrates points on a face for automatically detecting facial features according to one embodiment of the invention;

FIG. 8 illustrates the outlines created by the body detection module according to one embodiment of the invention; and

FIGS. 9A and B are a flow chart that illustrates steps for tracking faces and bodies in a video according to one embodiment of the invention.

### DETAILED DESCRIPTION OF THE INVENTION

### Client

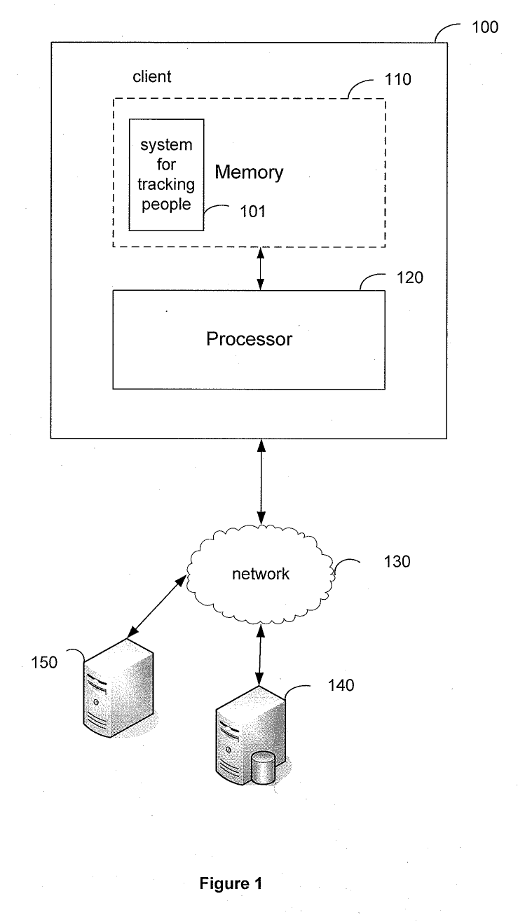

FIG. 1 is a block diagram of a client, network, and server architecture according to one embodiment of the invention. In one embodiment, the system for tracking people 101 in videos is a software application stored on a client 100, such as a personal computer. In another embodiment, some components are stored on a client 100 and other components are stored on a server, such as the database server 140 or a general purpose server 150, each of which is accessible via a network 130. In yet another embodiment, the application includes a browser-based application that is accessed from the client 100 where the processing of the components are stored on a server 140 150.

The client 100 is a computing platform configured to act as a client device, e.g. a computer, a digital media player, a personal digital assistant, etc. The client 100 comprises a processor 120 that is coupled to a number of external or internal inputting devices 105, e.g. a mouse, a keyboard, a display device, etc. The processor 120 is coupled to a communication device such as a network adapter that is configured to communicate via a communication network 130, e.g. the Internet. The processor 120 is also coupled to an output device, e.g. a computer monitor to display information.

The client 100 includes a computer-readable storage medium, i.e. memory 110. The memory 110 can be in the form of, for example, an electronic, optical, magnetic, or another storage device capable of coupling to a processor 120, e.g. such as a processor 120 in communication with a touch-sensitive input device. Specific examples of suitable media include flash drive, CD-ROM, read only memory (ROM), random access memory (RAM), application-specific integrated circuit (ASIC), DVD, magnetic disk, memory chip, etc. The memory can contain computer-executable instructions. The processor 120 coupled to the memory can execute computer-executable instructions stored in the memory 110. The instructions may comprise object code generated from any compiled computer-programming language, including, for example, C, C++, C# or Visual Basic, or source code in any interpreted language such as Java or JavaScript.

The network 130 can be a wired network such as a local area network (LAN), a wide area network (WAN), a home network, etc., or a wireless local area network (WLAN), e.g. Wifi, or wireless wide area network (WWAN), e.g. 2G, 3G, 4G.

### System

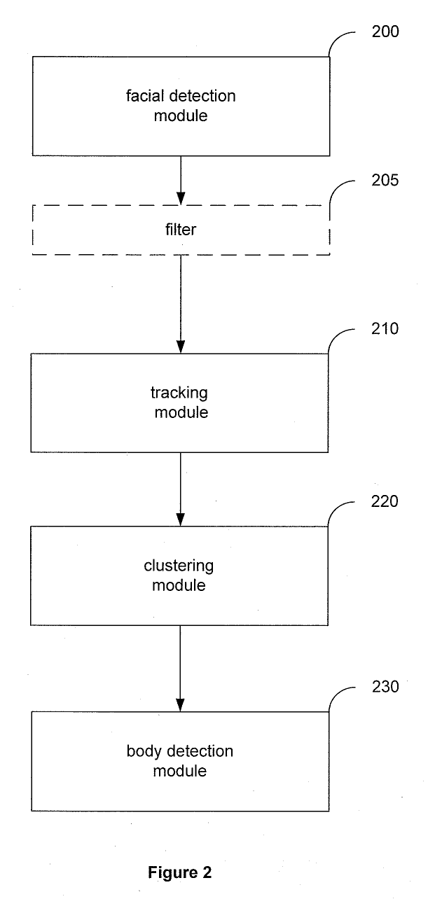

FIG. 2 is a block diagram that illustrates a system for tracking people in videos according to one embodiment of the invention. The system comprises four modules: a facial detection module 200 for detecting faces; a tracking module 210 for creating coherent face tracks and increasing the recall and precision of the raw face detector; a clustering module 220 for grouping the face tracks to form homogenous groups of characters; and a body detection module 230 for attaching bodies to the tracked faces. In one embodiment, a filter 205 for smoothing histograms is an additional component.

### Facial Detection

In one embodiment of the invention, the facial detection module 200 employs a modification of the algorithm described by Viola and Jones in “Robust Real-time Object Detection.”

Facial recognition involves detecting an object of interest. A video (V) is composed of a set of frames (fk ), such that:

V=f¹, f², . . . f^{k} (Eq. 1)

Facial recognition involves detecting an object of interest within the frame and determining where in the frame the object exists, i.e. which pixels in the frame correspond to the object of interest.

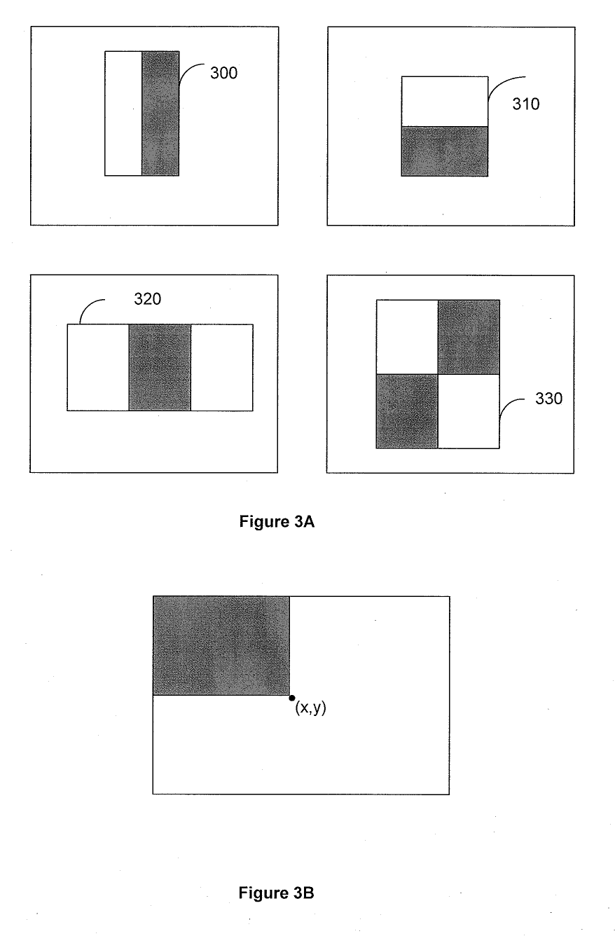

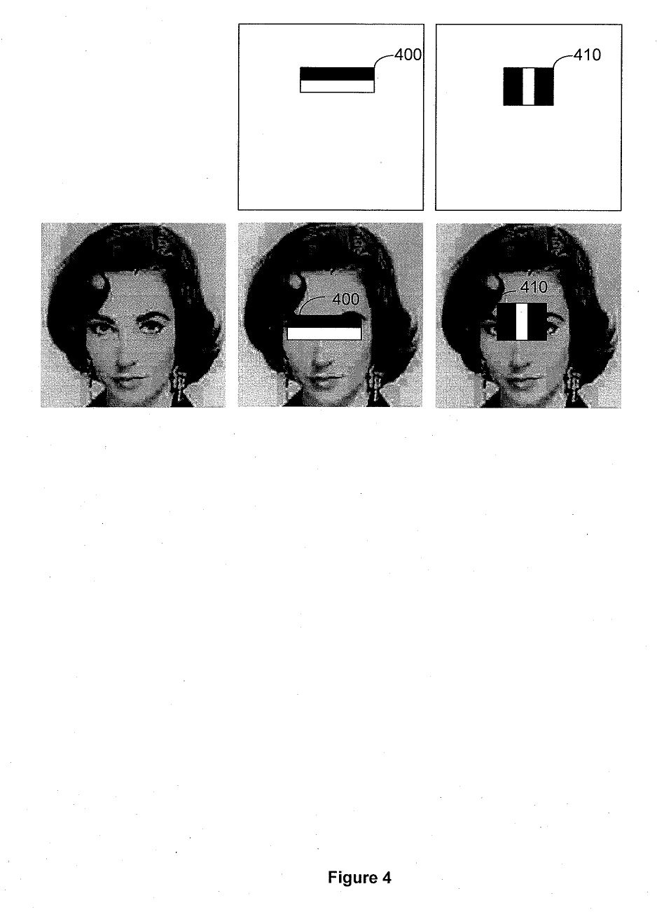

Images within each frame are classified based on the value of simple features. The Viola and Jones framework is applied with modifications. Three kinds of simple features are used: (1) a two-rectangle feature; (2) a three-rectangle feature; and (3) a four-rectangle feature. FIG. 3A is an example of rectangle features that are displayed relative to a detection window. The two-rectangle feature 300, 310 generates the difference between the sum of pixels within two rectangular regions. The three-rectangle feature 320 computes the sum within two outside rectangles subtracted from the sum in a center rectangle. The four-rectangle feature 330 computes the difference between diagonal pairs of rectangles.

The rectangle features are computed using an intermediate representation for the integral image. The integral image at x, y is the sum of the pixels above and to the left of x, y, inclusive:

$$ii ( x , y ) {\sum }_{{x}^{′} \leq x , {y}^{′} \leq y} i ( {x}^{′} , {y}^{′} ) \qquad ( Eq . 2 )$$

where ii(x, y) is the integral image and i(x,y) is the original image as illustrated in FIG. 3B.

Using the following pair of recurrences:

s(x,y)=s(x,y−1)+i(x,y) (Eq. 3)

ii(x,y)=ii(x−1,y)+s(x,y) (Eq. 4)

where s(x, y) is the cumulative row sum, s(x, −1)=0, and ii(−1, y)=0, the integral image is computed in one pass over the original image.

Each feature can be evaluated at any scale and location in a few operations. For example, the face detector module 200 scans the input starting at a base scale in which objects are detected at a size of 24 by 24 pixels. In one embodiment, the face detector module 200 is constructed with two types of rectangle features. In another embodiment, the face detector module 200 uses more than two types of rectangle features. While other face detector models using a shape other than a rectangle, such as a steerable filter, the rectangular features are processed more quickly. As a result of the computational efficiency of these features, the face detection process can be completed for an entire image at every scale at 20 frames per second.

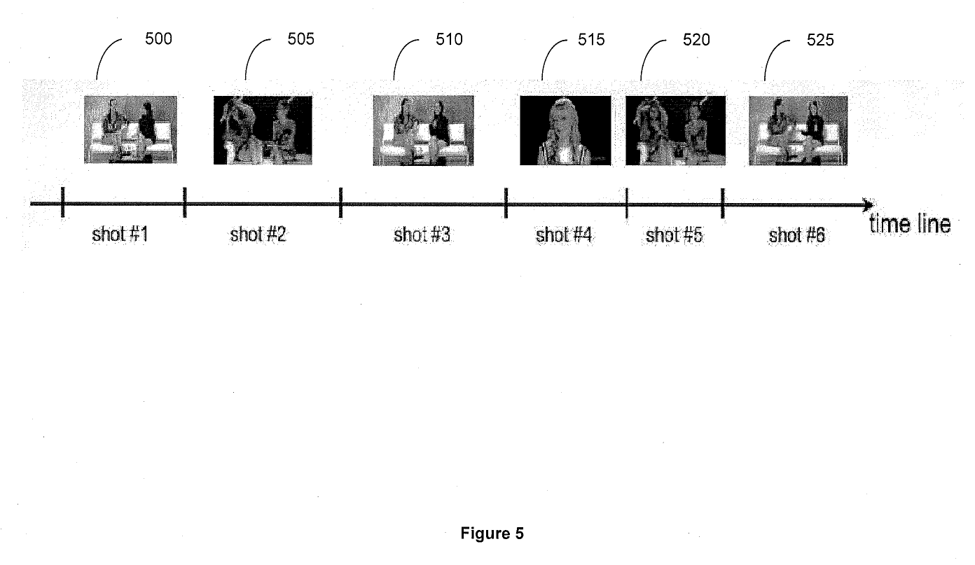

FIG. 4 illustrates a face and two regions where the rectangles are applied during facial recognition. The first region of a face that is most useful in facial detection is the eye region. The first feature 400 focuses on the property that the eye region is often darker than the region of the nose and cheeks. This region is relatively large in comparison with the detection sub-window, and is insensitive to size and location of the face. The second feature 410 relies on the property that the eyes are darker than the bridge of the nose.

The two features 400, 410 are shown in the top row and then overlaid onto a training face in the bottom row. The first feature 400 calculates the difference in intensity between a region of the eyes and a region across the upper cheeks. The second feature 410 calculates a difference in the region of the eyes and a region across the bridge of the nose. Based on only two rectangles, the facial detection module 200 generates a face detection. In one embodiment, additional rectangles are applied to generate a more accurate face detection. A person of ordinary skill in the art will recognize, however, that for each rectangle that is added, the computation time increases. In one embodiment, the face detection module 200 uses AdaBoost, a machine learning algorithm, to aid in generating the face detection.

In one embodiment, the accuracy of facial detection generated by the facial detection module 200 is improved by using a training model that compares the facial detection to a manually defined outline of an image, which is called a “ground truth.” In one embodiment, the ground truth is defined for an object of interest every four frames. The accuracy of the tracking module 210 is measured by computing the overlap between the face detection and the ground truth box using the Pascal challenge definition of overlap:

$$overlap ( {B}_{1} , {B}_{2} ) = \frac{area ( {B}_{1} ⋂ {B}_{2} )}{area ( {B}_{1} ⋃ {B}_{2} )} \qquad Eq . ( 11 )$$

where B₁ and B₂ are the two outlines to be compared.

A “recall” measures the ability to find all the faces marked in a ground-truth set. Here, the parameters of the face detection module 200 are modified to increase the overall recall of the detector, i.e. more detections per image are generated.

Tracks are reinitialized whenever the overlap of the face detection with ground truth was lower than the arbitrary value 0.4. Persons of ordinary skill in the art will recognize other numbers that can be substituted for 0.4. The Pascal challenge replicates the realistic scenario with a user monitoring the tracking module 210. In this embodiment, the user reinitializes the tracking module 210 whenever the match between the outline and the ground truth becomes poor.

In one embodiment, the training module uses training classifiers to improve the accuracy of the face detection module 200 to determine parameters for applying the rectangle features. The classifiers are strengthened through training by learning which sub-windows to reject for processing. Specifically, the classifier evaluates the rectangle features, computes the weak classifier for each feature, and combines the weak classifiers.

The facial detection module 200 analyzes both a front view and a side view of the face. In practice, however, the front-view face detector is superior in both recall and precision to the side-view face detector. The different detectors often fire in similar regions. As a result, if the overlap between detections is greater than 40%, the detections are combined by keeping only the results of the frontal detection and disregarding the profile detections. The overlap threshold can be modified. Tracking, which will be described in further detail below, increases the precision of the face-detector recall and increases the overall recall and performance of the system significantly.

Object and Image Representation

A color space is a model for representing color as intensity values. Color space is defined in multiple dimensions, typically one to four dimensions. One of the dimensions is a color channel. In an HSV color model, the colors are categorized according to hue, saturation, and value (HSV), where value refers to intensity.

As H varies from zero to one, the corresponding colors vary from red through yellow, green, cyan, blue, and magenta, back to red. As saturation varies from zero to one, the corresponding colors, i.e. hues, vary from unsaturated (shades of gray) to fully saturated (no white component). As value varies from zero to one, the corresponding colors become increasingly brighter.

In an HSV color space, images and regions are represented by color histograms. A color histogram is the representation of the distribution of colors in an image, which is constructed from the number of pixels for each color. The color histogram defines the probabilities of the intensities of the channels. For a three color channel system, the color histogram is defined as:

h_{A,B,C}(a,b,c)=N*Probability(A=a,B=b,C=c) (Eq. 5)

where A, B, and C represent the three color channels for HSV and N is the number of pixels in the image.

Each color channel is divided into 16 bins. Separate histograms are computed for the region of interest in the H, S, and V channels. Returning to FIG. 2, each histogram is smoothed by a low-pass filter to reduce boundary issues caused by discretizing, i.e. the process of converting a continuous space into discrete histogram bins. In one embodiment, the filter 205 is a part of the facial detection module 200. In another embodiment, the filter 205 is a separate component of the system. The filter 205 concatenates the smoothed histograms to form a representation of images or regions.

In contrast with a straight representation in HSV space, this representation comprises significantly less space, because the dimensional space is 16×3=48 as compared to a 163=4096 dimensional space. Decreased sparsity helps when matching regions representing the same object are exposed to different lighting conditions. Concatenated histograms do not define a proper probability density as they sum to three. This problem is corrected by normalizing all representation vectors by three.

To enrich the representation with some geometric information, regions are divided into four quadrants. Histograms are computed independently in each quadrant, and then concatenated to form the final representation.

### Tracking

The tracking module 210 performs template matching at the nodes of a grid and selects the candidate location that provides the best match. Starting from the reference position of the face detection at time t, at t+1, the tracking module 210 compares the candidate position to the histograms obtained at shifted positions along a grid, as well as scaled and stretched outlines. The grid density varies from two to 20 pixels, with the highest density about the reference position from time t.

Where mₜ is the region tracked at time t, the template at time t incorporates a component that relates to the ground truth model m₀ at time t=0, and a component that expresses the temporal evolution:

mₜ=α*m₀+(1−α)*mₜ₋₁ Eq. (6)

The best tracking results were obtained where α−0.7. Low values of αlead to drift, while an α that is too close to 1 is too sensitive to variations in pose or lighting conditions.

The similarity of the color histograms is calculated as a distance of representation vectors. In one embodiment, the histogram intersection is used, which defines the distance between histograms h and g as:

$$d ( h , g ) = \frac{{\sum }_{A}^{ } {\sum }_{B}^{ } {\sum }_{C}^{ } min ( h ( a , b , c ) , g ( a , b , c ) )}{min ( \vert h \vert , \vert g \vert )} \qquad Eq . ( 7 )$$

where A, B, and C are color channels, and |h| and |g| give the magnitude of each histogram, which is equal to the number of samples. The sum is normalized by the histogram with the fewest samples.

In another embodiment, the Bhattacharya distance, the Kullback Leibler divergence, or the Euclidean distance are used to obtain tracking results. The Bhattacharya distance is calculated using the following equation:

D_{B}(h,g)=−ln ∫\sqrt{h(x)g(x)dx} Eq. (8)

where the domain is x.

The Kullback-Leibler divergence is calculated using the following equation:

$${D}_{KL} ( H ‖ G ) = {\int }_{- ∞}^{∞} h ( x ) log \frac{h ( x )}{g ( x )} d x \qquad Eq . ( 9 )$$

where h and g are probability measures over a set x.

The Euclidean distance is calculated using the following equation:

$${d}^{2} ( h , g ) = {\sum }_{A}^{ } {\sum }_{B}^{ } {\sum }_{C}^{ } {( h ( a , b , c ) - g ( a , b , c ) )}^{2} \qquad Eq . ( 10 )$$

where d is the distance between the color histograms h and g, and a, b, and c are the color channels.

The tracking system is more computation intensive than some other systems, e.g. the mean-shift algorithm from Comaniciu. To compute histograms quickly, the tracking module 210 uses integral histograms, which are the multi-dimensional equivalent of classical integral images. Thus, computing a single histogram requires only 3 additions/subtractions for each histogram channel. The tracking module 210, according to a specific implementation in C++, runs at about 20 frames/second on DVD-quality sequences where the frame resolution is 720×480 pixels. Persons of ordinary skill in the art will recognize that other implementations of the tracking module and other modules are possible, for example, different programming languages.

Detecting and Grouping Shots

Most video content consists of a series of shots, which make up a scene. Each shot is defined as the video frames between two different camera angles. In other words, a shot is a consistent view of a video scene in which the camera used to capture the scene does not change. The shots within a scene contain the same, or at least most of the same objects, within them. The point at which a shot ends, e.g. when the camera switches from capturing one person speaking to another person speaking, is called a shot boundary. The accuracy of the tracking module is increased by using shot boundaries to define the end of each shot and to aid in grouping the shots within a scene.

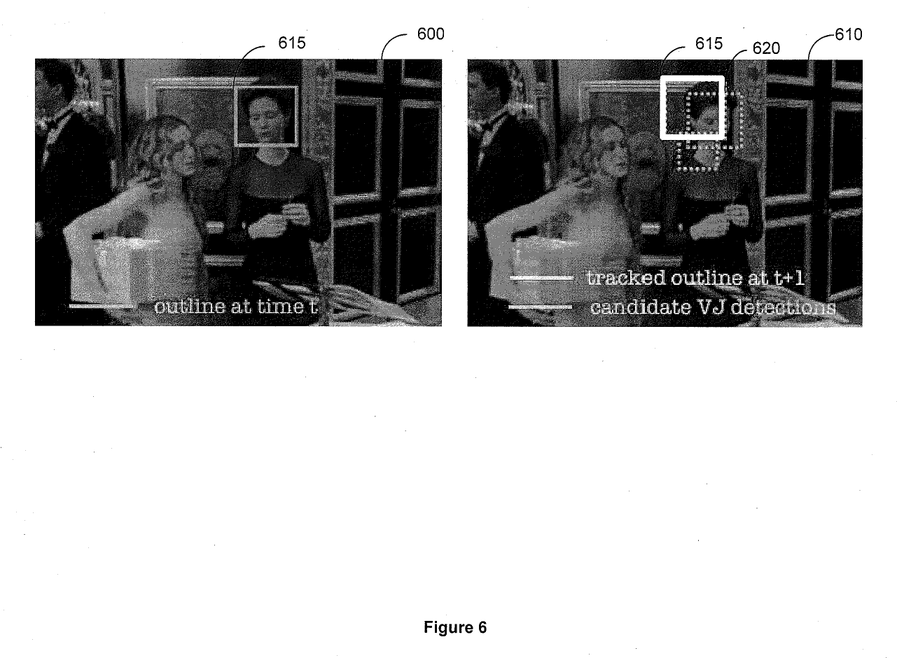

For example, consider FIG. 5, which illustrates a conversation between two actors in which the camera toggles between the multiple actors depending on who is speaking. A shot grouping algorithm detects shot boundaries and tracks across shot boundaries. This is referred to as “shot jumping” and occurs during post-processing. As a result, the tracking module 210 recognizes that certain shots should be grouped together because the camera angle differs only slightly from shot to shot. In FIG. 5, shot #1 500, shot #3 510, and shot #6 525 are grouped together. Similarly, shot #2 505 and shot #5 520 are grouped together. Shot jumping drastically extends the length of shots because otherwise, the shot would end each time the camera toggled between actors. Shot jumping is particularly useful for video content that switches regularly between several cameras, e.g. sitcoms, talk shows, etc.

Referring back to Equation 1, the video j is composed of a series of frames f: V=f¹,f², . . . f^{k}. The shot boundary is determined by first considering a function S, which returns a Boolean value:

S(f^{k},f^{k+1})∉{0,1} Eq. (12)

depending on whether or not there is a shot boundary between any two frames. By stepping through all the frames within a video, the tracking module 210 generates a Boolean vector with non-zero values indicating a shot detection.

Next, two consecutive images are compared to assess whether a shot boundary is present. Each image is initially divided into an m×n grid, resulting in a total of m×n different bins. Corresponding bins from consecutive images are compared to determine their differences:

T(f^{k},f^{k+1})=Σ_{m,n}D(f_{m,n}^{k}, f_{m,n}^{k+1})>T Eq. (13)

for the function T, D is the histogram difference for a particular color channel. The tracking module 210 counts the number of grid entries whose difference is above a particular threshold. If the percentage of different bins is too large, the two frames are different and qualify as a shot boundary.

In one embodiment, the tracking module 210 divided the image into four by four bins for a total of 16 unique areas and a shot-boundary is defined as D>T for more than six of the areas. The algorithm is applied to the entire video to find all the shot boundaries and to determine which shots are the same.

The tracking algorithm 210 determines which shots to group together by first demarking the indices of the frames that contain the shot boundaries as f^{h} and f^{j}. The five frames at the end of f^{h}, namely, f^{h-1} . . . f^{h-5} and the five frames after f^{j}, namely, f^{j+1} . . . f^{j+5} are used for comparison. For every pair of these frames, the tracking module 210 considers whether S==1, thereby indicating that there is a shot boundary. If none of the comparisons yields a shot boundary, the shots are the same and are grouped within the same shot cluster. A shot cluster is equivalent to a scene because a scene is composed of similar shots.

The threshold for defining shot boundaries is a compromise between a too-low threshold failing to connect similar shots where there is some movement of the actors or the camera and a too-high threshold where irrelevant shots are clustered together.

Creating Face Tracks

The tracking module 210 uses the temporal continuity between frames to track faces. In this example, the face detection dᵢ^{k} is in frame f^{k}. The tracking module 210 predicts the location of the track in frame f^{k+1}. In a set of n face detections in frame fₙ^{k+1}, if any of the n detections is close to the location predicted by tracking, the detection is the location of the track in frame f^{k+1}. In one embodiment, the face detection must overlap with the predicted location by 40% to qualify. The tracking module 210 continues both forwards and backwards in frame indices to build a homogenous object track that specifies the location of the object over time.

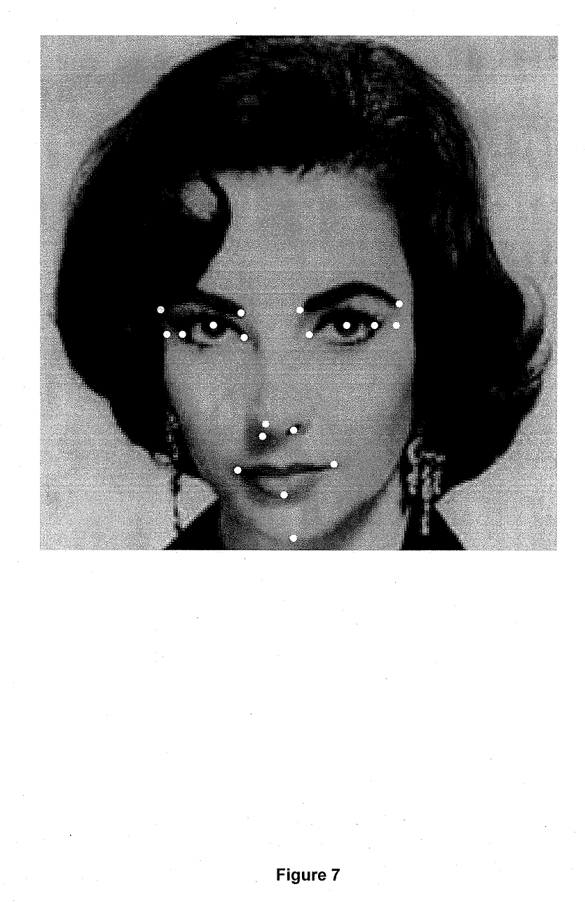

FIG. 6 illustrates the decision of where to place an outline according to one embodiment of the invention. The frame on the left 600 shows the outline of a woman who is facing the screen at time t. The frame on the right 610 at time t+1 illustrates that she is now looking downward. The solid outline 615 is the same outline depicted in the frame on the right 600. The dashed outlines represent candidates for the outlines that provide the best overlap with the tracked outline. The tracking module 210 selects the outline with the best match, as long as the overlap exceeds a pre-defined threshold. Here, 620 is closest to the tracked outline and also represents the best match for the face, since the other candidate outline fails to even include portions of the face within its boundaries.

The tracking module 210 uses face detection to confirm the predicted location for tracking because all tracking algorithms experience drift unless they are re-initialized. Face detection re-initializes the tracking algorithm, which is a more reliable indicator of the true location of the face.

Track Termination

The tracking module 210, as illustrated in FIG. 2, terminates a track in two situations to avoid drift. First, when a face-track d with an outline i in frame k is denoted by dᵢ^{k}, the track is terminated when the predicted region from tracking falls below a specified threshold and there is no face detection near the predicted region. Enforcing a face track period that requires face detection periodically results in more homogenous tracks with little drift. Second, if the face track grows without encountering a face detection, the track is deemed lost. These mechanisms avoid a situation where the face track grows over many frames by tracking an inappropriate object.

Track Collisions

Track collisions occur when two tracks cross each other. For example, an actor in a scene walks past another actor. The tracking module 210 avoids confusing the different tracks for each actor by splitting each track into two separate tracks at the point of collision. This results in four unique tracks. As described below, the clustering module 220 groups the tracks together again during post-processing.

Filtering Resulting Tracks

Another post-processing technique performed by the tracking module 210 is to reduce the false positive rate by removing face tracks that fail to incorporate sufficient face detections. In one embodiment, the tracking module 210 uses at least five detections within a track. For tracks over 25 frames, at least ten percent of the frames contain facial detection. The tracking module 210 removes spurious face tracks where facial detections were not found. As a result, each face track contains a homogenous set of faces corresponding to a particular individual over consecutive frames.

### Track Clustering

The clustering module 220 generates a similarity matrix between tracks and applies a hierarchical agglomertative clustering to cluster the tracks for each person. The video contains homogenous clustering where each cluster represents a unique individual. These steps are described in more detail below.

Distance between Tracks

In one embodiment, the distance between two tracks is defined as the minimum pairwise distance between faces associated with the tracks.

Distance between Faces

The clustering module 220 normalizes and rectifies the faces before calculating a distance by: (1) detecting facial features, (2) rectifying the faces by rotating and scaling each face so that the corners of the eyes have a constant position, and (3) then normalizing the rectified faces by normalizing the sum of their squared pixel values to reduce the influence of lighting conditions. The distance between two faces that have been rectified and normalized is calculated using the Euclidean distance defined in Equation 10.

The facial features are detected by locating landmarks in the face, i.e. distinguishable points present in the images such as the location of the left eye pupil. A set of landmarks forms a shape. The shapes are represented as vectors. The shapes are aligned with a similarity transform that enables translation, scaling, and rotation by minimizing the average Euclidean distance between shape points. The rotating and scaling preserve the shape of the face, i.e., a long face stays long and a round face stays round. The mean shape is the mean of the aligned training shapes. In one embodiment, the aligned training shapes are manually landmarked faces.

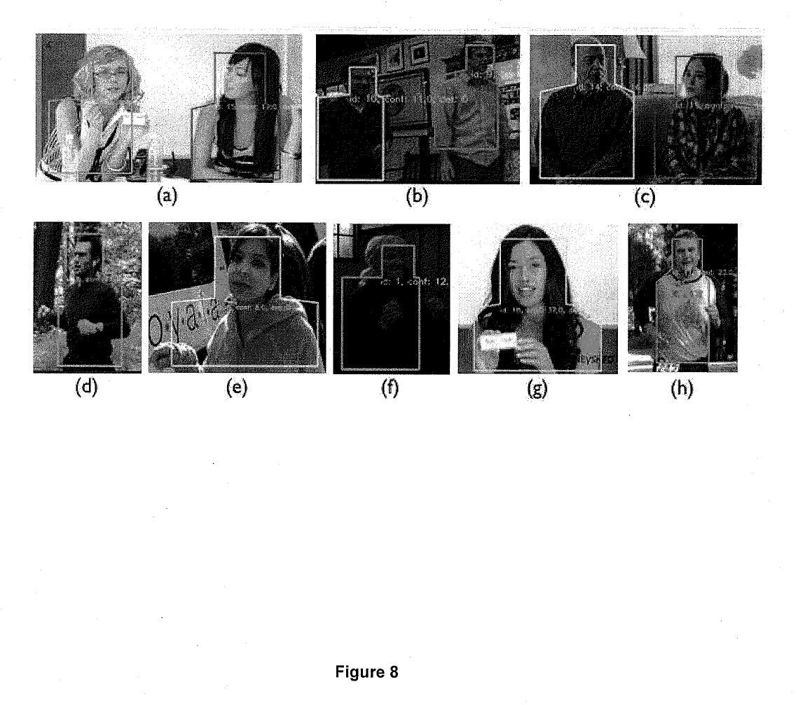

FIG. 7 illustrates potential points in a face for establishing landmarks according to one embodiment of the invention. In this model, the landmarks are defined as the pupils, the corners of each eye, the edges of each eyebrow, the center of each temple, the top of the nose, the nostrils, the edges of the mouth, the center of the bottom lip, and the center of the chin.

The landmarks are generated by determining a global shape model based on the position and size of each face as defined by the facial detection module 200. A candidate shape is generated by adjusting the location of shape points by template matching of the image texture around each point. The candidate shape is adjusted to conform to the global shape model. Instead of using individual template matches, which are unreliable, the global shape model pools the results of weak template matches to form a stronger overall classifier.

The process of adjusting to conform to the global shape model can adhere to two different models: the profile model and the shape model. The profile model locates the approximate position of each landmark by template matching. The template matcher forms a fixed-length normalized gradient vector, called the profile, by sampling the image along a line, called the whisker, orthogonal to the shape boundary at the landmark. During training on manually landmarked faces, at each landmark the mean profile vector g̅ and the profile covariance matrix S_{g} are calculated. During searching, the landmark is displayed along the whisker to the pixel with a profile g that has the lowest Mahalanobis distance from the mean profile g̅. The Mahalanobis distance is calculated as follows:

Mahalanobis distance=(g− g̅)^{T}S_{g}⁻¹(g− g̅) Eq. (14)

The shape model specifies constellations of landmarks. Shape \hat{x} is generated using the following equation:

\hat{x}= x̅+Φb Eq. (15)

where x̅ is the mean shape, b is a parameter vector, and Φ is a matrix of selected eigenvectors of the covariance matrix S_{S} of the points of the aligned training shapes. Using a principal components approach, variation in the training set is modeled according to defined parameters by ordering the eigenvalues λ₁ of S_{S} and keeping an appropriate number of the corresponding eigenvectors in Φ. The shape model is used for the entire model, but scaled for each pyramid level.

Equation 15 is used to generate various shapes by varying the vector parameter b. By keeping the elements of b within limits that are determined during model building, the generated face shapes are lifelike. Conversely, given a suggested shape x, the parameter b is calculated to best approximate x with a model shape \hat{x}. In this case, the distance is minimized using an iterative algorithm that gives b and T:

distance=(x,T( x̅+Φb)) Eq. (16)

where T is a similarity transform that maps the model space into the image space.

Agglomerative Clustering

The clustering module 220 uses the distance between faces to generate a similarity matrix between tracks. There are a variety of clustering algorithms that can be used. A clustering algorithm that groups things together is referred to as agglomerative. A hierarchical clustering algorithm finds successive clusters using previously established clusters, which are typically represented as a tree called a dendrogram.

A hierarchical agglomerative clustering algorithm is well suited for forming clusters using the distance matrix. Rows and columns in the distance matrix are merged into clusters. Because hierarchical clustering does not require a prespecified number of clusters, the clustering module 220 must determine how to group the different clusters and when they should be merged. In the preferred embodiment, the merging is determined using complete-link clustering, where the similarity between two clusters is defined as the similarity between their most dissimilar elements. This is equivalent to choosing the cluster pair whose merge has the smallest diameter.

In another embodiment, single-link, group-average, or centroid clustering is used to calculate a cutoff. In single-link clustering, clusters are grouped according to the similarity of the members. Group-average clustering uses all similarities of the clusters, including similarities within the same cluster group to determine the merging of clusters. Centroid clustering considers the similarity of the clusters, but unlike the group-average clustering, does not consider similarities within the same cluster.

A delicate parameter is the threshold that determines how close tracks need to be in order to be clustered together, i.e. when the clustering stops. In one embodiment, this threshold is determined empirically, as a fixed percentile of the sorted values in the distance matrix. In another embodiment, the threshold is determined naturally, i.e. when there is a steep gap between two successive combinations.

### Body Detection

The body detection module 230 as illustrated in FIG. 2 attaches a body outline to each frame within a face track. The extension of the face outline to the body results in a large interactive region for clickable applications. For example, any clothing that the user is wearing can be associated with the particular user. Using the facial detection module 200 as a prior probability distribution, i.e. a prior for the location of the body, drastically reduces the possible locations of the body within a particular frame. In addition, defining the face according to a specific location creates a strong likelihood that a body exists below that location. These assumptions are incorporated into the body detection module 230.

The body detection module 230 incorporates two implicit priors. First, the body is composed of homogenous regions that can be segmented using traditional segmentation methods. Second, the body is in an area below the detected face.

The body detection module 230 selects a region of interest called a ROI_{body} below the face that is a multiple of three to four times the width and height of the face outline within the face-track. The ROI_{body} is large enough to account for varying body sizes, poses, and the possibility of the body not lying directly below the face, which occurs, e.g. when a person leans forward.

The body detection module 230 segments the ROI_{body} into regions pₖ of pixels that are similar in color using the Adaptive Clustering Algorithm (ACA). This algorithm begins with the popular K-Means clustering algorithm and extends it to incorporate pixel location in addition to color.

A subregion of ROI_{body} that is the same width as the face and ½ the height of ROI_{body} that is at the center of ROI_{body} is considered. The subregion is called ROIₕᵢₛₜ because the body detection module 230 takes the histogram of the pₖ that fall within the subregion. The colors Cₚ₀ and Cₚ₁ are two colors that occupy the most area within ROIₕᵢₛₜ. P_{C0} and P_{C1} are the sets of pixels in ROI_{body} who's R, G, and B values are within 25 of those of either Cₚ₀ or Cₚ₁. Furthermore, the ratio α of the relative importance between the top two representative colors is below:

$$α = \frac{\vert {P}_{c 0} \vert}{\vert {P}_{c 0} \vert + \vert {P}_{c 1} \vert} \qquad Eq . ( 17 )$$

Because these colors were found within ROIₕᵢₛₜ, which is a region just below the face, these two colors are assumed to represent the two dominant colors of the upper torso.

The body detection module 230 determines the largest rectangle in ROI_{body} that maximizes a scoring function S:

S_{{B}_{_{w}}_{,B}_{ₕ}_{,B}_{ₓ}_{,B}_{_{y}}_{}=α|P}_{_{C0}}_{|+(1-α)|P}_{_{C1}}_{|-γ(pix∉{P}_{_{C0}}_{νP}_{_{C1}}_{})} Eq. (18)

where B_{w} and Bₕ are the width and height of the candidate rectangles', while Bₓ and B_{y} are the (x,y) center positions of the candidate rectangles. In one embodiment, γ was empirically determined to be 1.4. Maximizing S generates the largest rectangle that has the highest density of pixels that belong to either P_{C0} or P_{C1}, maintaining their relative importance and the fewest of other pixels.

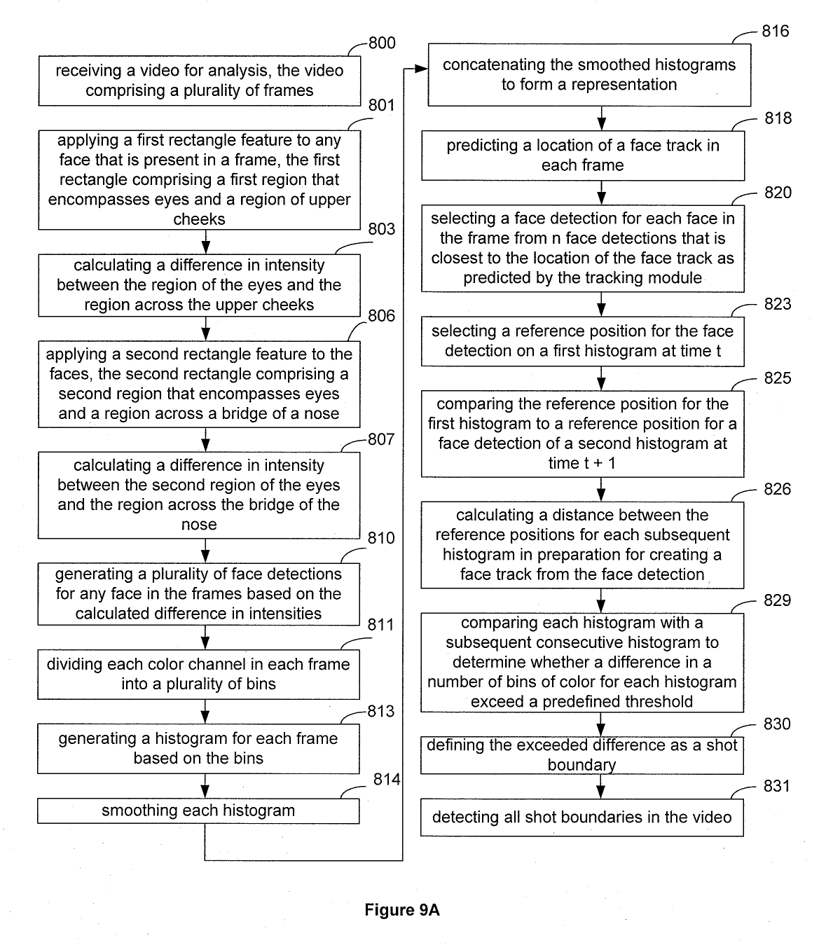

FIG. 8 illustrates different frames where the outline of bodies was detected with varying degrees of success according to one embodiment of the invention. Frames (a) through (h) show strong detection results that exhibit a high degree of overlap with the actual body. The body detection module 230 performed best when only one person or multiple people with ample space between their bodies were in the frame.

### Flow Chart

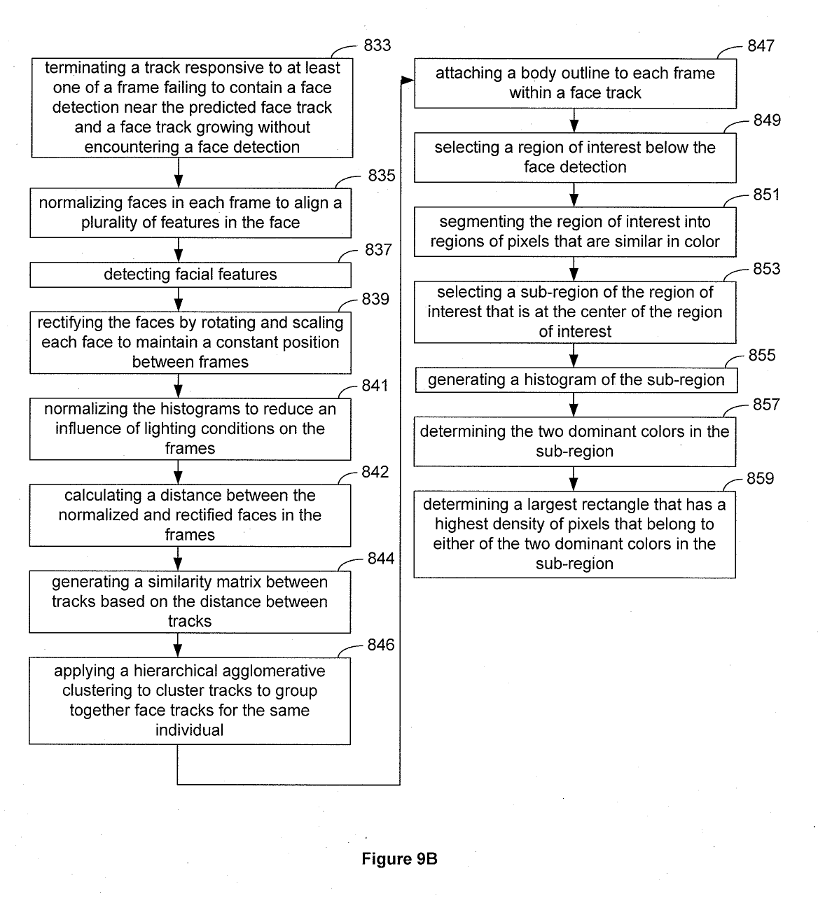

FIGS. 9A and 9B are a flow chart that illustrates steps for creating tracks according to one embodiment of the invention. The system receives 800 a video for analysis, the video comprising a plurality of frames. The facial detection module 200 applies 801 a first rectangle feature to any face that is present in a frame, the first rectangle comprising a first region that encompasses eyes and a region of the upper cheeks. The facial detection module 200 calculates 803 a difference in intensity between the region of the eyes and the region across the upper cheeks. The facial detection module 200 applies 806 a second rectangle feature to the faces, the second rectangle comprising a second region that encompasses eyes and a region across a bridge of a nose. The facial detection module 200 calculates 807 a difference in intensity between the second region of the eyes and a region across the bridge of the nose. The facial detection module 200 generates 810 a plurality of face detections for any face in the frames based on the calculated differences in intensities.

The face detection module 200 divides 811 each color channel in each frame into a plurality of binds. The face detection module 200 generates 813 a histogram for each frame based on the binds. A filter 205 smoothes 814 each histogram. The filter 205 concatenates 816 the smoothed histograms to form a representation.

A tracking module 210 predicts 818 a location of a face in each frame. The tracking module 210 selects 820 a face detection for each face in the frame from n face detections that is closest to the location of the face track as predicted by the tracking module 210.

The tracking module 210 selects 823 a reference position for the face detection on a first histogram at time t. The tracking module 210 compares 825 the reference position for the first histogram to a reference position for a face detection of a second histogram at time t+1. The tracking module 200 calculates 826 a distance between the reference positions for each subsequent histogram in preparation for creating a face track from the face detection. The tracking module 200 compares 829 each histogram with a subsequent consecutive histogram to determine whether a difference in a number of bins of color for each histogram exceed a predefined threshold. The tracking module 200 defines 830 the exceeded difference as a shot boundary. The tracking module 200 detects 831 all shot boundaries in the video. The tracking module 200 terminates 833 a track responsive to at least one of: a frame failing to contain a face detection near the predicted face track and a face track growing without encountering a face detection.

A clustering module 220 normalizes 835 faces in each frame to align a plurality of features in the face by: (1) detecting 837 facial features; (2) rectifying 839 the faces by rotating and scaling each face to maintain a constant position between frames; and (3) normalizing 841 the histograms to reduce an influence of lighting conditions on the frames. The clustering module 220 calculates 842 a distance between the normalized and rectified faces in the frames. The clustering module 220 generates 844 a similarity matrix between tracks based on the distance between tracks. The clustering module 220 applying 846 a hierarchical agglomerative clustering algorithm to cluster tracks to group together face tracks for the same individual.

The body detection module 220 attaches 847 a body outline to each frame within a face track by selecting 849 a region of interest below the face detection, segmenting 851 the region of interest into regions of pixels that are similar in color, selecting 853 a sub-region within the region of interest that is at the center of the region of interest, generating 855 a histogram of the sub-region, determining 857 the two dominant colors in the sub-region, and determining 859 a largest rectangle that has a highest density of pixels that belong to either of the two dominant colors in the sub-region.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer implemented method for tracking faces and bodies in videos, the method comprising the steps of:
providing a computer comprising a processor and a memory, the processor configured to implement instructions stored in the memory, the processor performing the following steps:
receiving a video for analysis, the video comprising a plurality of frames;
calculating a difference in intensity between different regions of any face in the frames;
generating a plurality of face detections for each face in the frames;
dividing each color in each frame into a plurality of bins;
generating a histogram for each frame based on the bins;
smoothing each histogram;
concatenating the smoothed histograms;
predicting a location of a face in each frame;
selecting a face detection from the plurality of face detections for each face in the frame, the selected fade detection being closest to the predicted location of the face;
selecting a reference position for the face detection on a first histogram at time t;
comparing the reference position for the first histogram to a reference position for a face detection of a second histogram at time t+1;
calculating a distance between the reference positions for each subsequent histogram in preparation for creating a face track from the face detection;
comparing each histogram with a subsequent consecutive histogram to determine whether a difference in a number of bins of color for each histogram exceed a predefined threshold;
defining the exceeded difference as a shot boundary;
detecting all shot boundaries in the video;
normalizing and rectifying faces in each frame to align a plurality of features in the face;
calculating a distance between the normalized and rectified faces in the frames;
generating a similarity matrix between tracks based on the distance between tracks;
clustering tracks to group together face tracks for a each person in the video; and
attaching a body outline to each frame within a face track.

2. The method of claim 1, wherein a Euclidean distance is used to calculate distances between faces.

3. The method of claim 1, wherein a complete link clustering is used to calculate a cutoff for grouping clusters.

4. The method of claim 1, wherein the steps for generating a face detection further comprises the steps of:
applying a first rectangle feature to any face that is present in a frame, the first rectangle comprising a first region that encompasses eyes and a second region of upper cheeks;
calculating a difference in intensity between the first and second regions;
applying a second rectangle feature to the faces, the second rectangle comprising a third region that encompasses eyes and a fourth region across a bridge of a nose; and
calculating a difference in intensity between the third and fourth regions.

5. The method of claim 1, wherein responsive to a collision between two face tracks, the processor further performs the steps of:
splitting each track into two separate tracks at a point of collision; and
grouping the face tracks back together.

6. The method of claim 1, further comprising the step of terminating a track responsive to at least one of: a frame failing to contain a face detection near the predicted face track and a face track growing without encountering a face detection.

7. The method of claim 1, wherein the step of clustering further comprises:
detecting facial features;
rectifying the faces by rotating and scaling each face to maintain a constant position between frames; and
normalizing the histograms to reduce an influence of lighting conditions on the frames.

8. The method of claim 1, wherein the clustering is a hierarchical agglomerative clustering.

9. The method of claim 1, wherein the step of attaching a body outline to each frame further comprises the steps of:
selecting a region below the face detection;
segmenting the region into groups of pixels that are similar in color;
selecting a sub-region that is at the center of the region;
generating a histogram of the sub-region;
determining the two dominant colors in the sub-region; and
determining a largest rectangle that has a highest density of pixels that belong to either of the two dominant colors in the sub-region.

10. The method of claim 1, wherein the body outline is generated responsive to any of the body being composed of homogenous regions that can be segmented and the body is in an area below the detected face.

11. A computer program product for tracking faces and bodies in a video comprising a computer-readable storage medium storing program code for executing the following steps:
receiving a video for analysis, the video comprising a plurality of frames;
calculating a difference in intensity between different regions of any face in the frames;
generating a plurality of face detections for each face in the frames;
dividing each color in each frame into a plurality of bins;
generating a histogram for each frame based on the bins;
smoothing each histogram;
concatenating the smoothed histograms;
predicting a location of a face in each frame;
selecting a face detection from the plurality of face detections for each face in the frame that is closest to the predicted location of the face;
selecting a reference position for the face detection on a first histogram at time t;
comparing the reference position for the first histogram to a reference position for a face detection of a second histogram at time t+1;
calculating a distance between the reference positions for each subsequent histogram in preparation for creating a face track from the face detection;
comparing each histogram with a subsequent consecutive histogram to determine whether a difference in a number of bins of color for each histogram exceed a predefined threshold;
defining the exceeded difference as a shot boundary;
detecting all shot boundaries in the video;
normalizing and rectifying faces in each frame to align a plurality of features in the face;
calculating a distance between the normalized and rectified faces in the frames;
generating a similarity matrix between tracks based on the distance between tracks;
clustering tracks to group together face tracks for a each person in the video; and
attaching a body outline to each frame within a face track.

12. A system for tracking faces and bodies in videos, comprising:
a memory;
a processor, the processor configured to implement instructions stored in the memory, the memory storing executable instructions and a video for analysis, the video comprising a plurality of frames;
a facial detection module for calculating a difference in intensity between a plurality of regions of any face that is present in a frame and generating a plurality of face detections, the facial detection module generating a histogram for each frame;
a filter for smoothing the histogram for each frame and concatenating the smoothed histograms;
a tracking module for predicting a location of a face in each frame, comparing the location to the plurality of face detections for each face, and selecting the face track that is closest to the predicted location as long as the overlap between the predicted location and the selected face track exceeds a threshold level, the tracking module detecting all shot boundaries in the video by calculating a distance between the reference positions for each subsequent histogram and comparing each histogram with a subsequent consecutive histogram to determine whether a difference in color for each histogram exceeds a predefined threshold;
a clustering module for normalizing and rectifying the faces in the frames and clustering the normalized and rectified faces for each person in the video; and
a body detection module for generating a body outline and associating it with the face diction.

13. The system of claim 12, wherein the tracking module incorporates a ground truth model.

14. The system of claim 12, wherein the histograms are divided into quadrants and concatenated to form a final representation.

15. The system of claim 12, wherein the similarity between histograms is calculated using a histogram intersection.

16. The system of claim 12, wherein the overlap between the predicted location and the closest face detection is 40%.

17. The system of claim 12, wherein the facial detection module analysis any of frontal views and side profiles of faces.

18. The system of claim 12, wherein the colors in the histograms are categorized according to hue, saturation, and value.

19. The system of claim 12, wherein the face track is terminated if any of: the overlap between the predicted location and the face detections falls below the threshold level and the face track grows without encountering a facial detection.

20. The system of claim 12, wherein a parameter for determining when to stop clustering tracks is a fixed percentile of sorted values in the distance matrix.
